(19) United States
(12) Patent Application Publication
(10) Pub. No.: US 2025/0013551 A1
(43) Pub. Date: Jan. 9, 2025

(54) METHOD FOR EVALUATING MODEL SERVICE, ELECTRONIC DEVICE AND STORAGE MEDIUM

(71) Applicant: Beijing Baidu Netcom Science Technology Co., Ltd., Beijing (CN)

(72) Inventors: Chengcheng WU, Beijing (CN); Ye ZHANG, Beijing (CN); Baoju LIU, Beijing (CN); Zeyu WANG, Beijing (CN)

(21) Appl. No.: 18/890,749

(22) Filed: Sep. 19, 2024

(30) Foreign Application Priority Data
Apr. 3, 2024 (CN) 202410404304.8

(51) Int. Cl. G06F 11/34

(52) U.S. Cl. CPC G06F 11/3452

(57) ABSTRACT

The present disclosure provides a method and apparatus for evaluating a model service, an electronic device, and a storage medium, relates to the technical field of edge computers, in particular to the technical fields of intelligent Internet of Things, edge intelligent devices, or the like. A specific implementation solution is as follows: receiving an evaluation sample set from cloud, the evaluation sample set including a to-be-evaluated model and a dataset corresponding to the to-be-evaluated model and containing labelling information; performing model inference on the to-be-evaluated model based on data in the dataset, to obtain an inference result corresponding to the to-be-evaluated model; and calculating a performance evaluation metrics based on the labelling information in the dataset and the inference result, to obtain an evaluation result corresponding to the to-be-evaluated model.

### CROSS-REFERENCE TO RELATED APPLICATIONS

This application claims priority to Chinese Patent Application No. 202410404304.8, filed with the China National Intellectual Property Administration (CNIPA) on Apr. 3, 2024, the content of which is incorporated herein by reference in its entirety.

### TECHNICAL FIELD

The present disclosure relates to the technical field of edge computers, in particular to the technical fields of intelligent Internet of Things, edge intelligent devices, or the like, more particularly, to a method for evaluating a model service, an electronic device, and a storage medium.

### BACKGROUND

Cloud edge collaboration is a system architecture for distributed deployment and unified management of infrastructure resources. Unlike cloud manufacturing which concentrates all computing services to a cloud data centre, cloud edge collaboration adopts Internet of Things (IoT) to achieve real-time perception of distributed industrial equipment, and uploads data information of terminal devices to near-end edge nodes through an intelligent gateway. The edge nodes take collected measurement data in the form of time series, and perform big data processing through parallelized local computing services, so as to achieve autonomous control and decision-making of machine equipment and individualized automatic regulation of production processes, and provide intelligent services such as processing quality inspection, manufacturing resource scheduling, or logistics control for intelligent factories.

### SUMMARY

The present disclosure provides a method and apparatus for evaluating a model service, an electronic device, and a storage medium.

According to an aspect of the present disclosure, a method for evaluating a model service is provided, applied to an edge device, including: receiving an evaluation sample set from cloud, the evaluation sample set including a to-be-evaluated model and a dataset corresponding to the to-be-evaluated model and containing labelling information; performing model inference on the to-be-evaluated model based on data in the dataset, to obtain an inference result corresponding to the to-be-evaluated model; and calculating a performance evaluation metrics based on the labelling information in the dataset and the inference result, to obtain an evaluation result corresponding to the to-be-evaluated model.

According to another aspect of the present disclosure, an apparatus for evaluating a model service is provided, including: a receiving module, configured to receive an evaluation sample set from cloud, the evaluation sample set comprising a to-be-evaluated model and a dataset corresponding to the to-be-evaluated model and containing labelling information; an inference module, configured to perform model inference on the to-be-evaluated model based on data in the dataset, to obtain an inference result corresponding to the to-be-evaluated model; and an evaluation module, configured to calculate a performance evaluation metrics based on the labelling information in the dataset and the inference result, to obtain an evaluation result corresponding to the to-be-evaluated model.

According to a third aspect of the present disclosure, an electronic device is provided, comprising: one or more processors; and a memory, storing one or more programs, wherein the one or more programs, when executed by the one or more processors, cause the one or more processors to implement the method described in any of the above technical solutions.

According to a fourth aspect of the present disclosure, a computer-readable medium is provided, storing a computer program thereon, wherein the program, when executed by a processor, causes the processor to implement the method described in any of the above technical solutions.

According to a fifth aspect of the present disclosure, a computer program product is provided, comprising a computer program, wherein the computer program, when executed by a processor, implements the method described in any of the above technical solutions.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for a better understanding of the present solution, and do not constitute a limitation of the present disclosure. In which:

FIG. 1 is a schematic diagram of steps of a

method for evaluating a model service in an embodiment of the present disclosure;

FIG. 2 is a schematic flowchart corresponding to the method for evaluating a model service in an embodiment of the present disclosure;

FIG. 3 is a schematic flowchart corresponding to an existing method for evaluating a model service in an embodiment of the present disclosure;

FIG. 4 is a schematic flowchart corresponding to the method for evaluating a model service in an embodiment of the present disclosure;

FIG. 5 is a principle block diagram of an apparatus for evaluating a model service in an embodiment of the present disclosure; and

FIG. 6 is a block diagram of an electronic device used to implement the method for evaluating a model service according to embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skilled in the art that various changes and modifications may be made to the embodiments described herein without departing from the scope and spirit of the present disclosure. Also, for clarity and conciseness, descriptions for well-known functions and structures are omitted in the following description.

The present disclosure provides a method for evaluating a model service, applied to an edge device, an executing body of the present solution is an edge end, referring to FIG. 1, the method including:
Step S101, receiving an evaluation sample set from cloud, the evaluation sample set including a to-be-evaluated model and a dataset corresponding to the to-be-evaluated model and containing labelling information.

In particular, for the evaluation sample set, after receiving an evaluation request, a central server in the cloud pushes and distributes the to-be-evaluated model and the dataset to an edge management central end, and the edge management central end distributes these materials received to the corresponding edge device, and then the edge device distributes the obtained to-be-evaluated model and the dataset to an edge node. For the to-be-evaluated model and the dataset corresponding to the to-be-evaluated model, it should be noted that if the to-be-evaluated model is an audio-type model, the corresponding dataset is a sample set of audios. If the to-be-evaluated model is a video-type model, the corresponding dataset is a video-type dataset, or if the to-be-evaluated model is a natural language-type model, the corresponding dataset is a natural language-type dataset, and so on. The specific model and the specific dataset here may be set according to actual needs, and will not be limited herein.
Step S102, performing model inference on the to-be-evaluated model based on data in the dataset, to obtain an inference result corresponding to the to-be-evaluated model.

In particular, after obtaining the to-be-evaluated model, the to-be-evaluated model is run. After the to-be-evaluated model is run, model inference is performed on the to-be-evaluated model based on the dataset corresponding to the to-be-evaluated model, so that the inference result corresponding to the to-be-evaluated model may be obtained. Here, the model inference refers to using the to-be-evaluated model to predict the data in the dataset, so that the inference result corresponding to the to-be-evaluated model may be obtained.
Step S103, calculating a performance evaluation metrics based on the labelling information in the dataset and the inference result, to obtain an evaluation result corresponding to the to-be-evaluated model.

In particular, the performance evaluation metrics refers to a metrics for model accuracy/performance evaluation, such as an accuracy rate, or a prediction delay, which are calculated based on the data labelling information and the model inference result. After obtaining the labelling information in the dataset and the inference result, the performance evaluation metrics is calculated based on the two pieces of data, the labelling information in the dataset and the inference result, which may achieve a stability pressure test on the model, or evaluate a functionality metrics, so as to obtain the evaluation result corresponding to the to-be-evaluated model.

The present disclosure provides the method and apparatus for evaluating a model service, the device, and the storage medium, by receiving an evaluation sample set from the cloud, and performing performance evaluation on a to-be-evaluated model in the evaluation sample set, to obtain an evaluation result corresponding to the to-be-evaluated model, the present disclosure can achieve flexible distribution of model services from the central end to the edge end, enabling users to control and manage model services on edge devices in a finer way, and improving flexibility of the overall system.

In some alternative embodiments, the performing model inference on the to-be-evaluated model based on data in the dataset, to obtain an inference result corresponding to the to-be-evaluated model, includes: performing model inference on the dataset corresponding to the to-be-evaluated model by means of a model inference component, to obtain the inference result corresponding to the to-be-evaluated model.

In particular, the model inference component may be used for performing model inference, when performing model inference on the to-be-evaluated model based on the dataset. In this way, the model inference component facilitates obtaining the inference result corresponding to the to-be-evaluated model.

In some alternative embodiments, the performing model inference on the dataset corresponding to the to-be-evaluated model by means of a model inference component, to obtain the inference result corresponding to the to-be-evaluated model, includes: parsing the data in the dataset corresponding to the to-be-evaluated model to obtain a parsed dataset; traversing the parsed dataset and converting the parsed dataset into input parameters of the model inference component; and performing inference based on the input parameters of the model inference component, to obtain the inference result corresponding to the to-be-evaluated model.

In particular, for the model inference component, its corresponding runtime logic contains the following process: parsing the obtained dataset; if it is required to collect an “average inference delay” metrics at the same time, warming up may be performed on the model; then traversing samples and converting the samples into model service inputs, initiating an inference request, to obtain the inference result; converting the inference result into a standard format; writing the inference result in the standard format into a result file, if there is other information to be output, the information may be written into the result file, so that it may facilitate reading from a subsequent component and then looking at an implementing process of a metrics calculation component.

In this way, by first parsing the dataset and converting the parsed dataset into the input parameters corresponding to the model inference component, and then performing inference based on the input parameters of the model inference component, it is beneficial to obtain the inference result corresponding to the to-be-evaluated model.

In some alternative embodiments, the calculating a performance evaluation metrics based on the labelling information in the dataset and the inference result, to obtain an evaluation result corresponding to the to-be-evaluated model, includes: calculating the performance evaluation metrics on the labelling information in the dataset and the inference result by means of a metrics evaluation component, to obtain the evaluation result corresponding to the to-be-evaluated model.

In particular, the metrics evaluation component may be used for performing model inference, when performing performance evaluation on the to-be-evaluated model based on the dataset. In this way, the metrics evaluation component facilitates obtaining the evaluation result corresponding to the to-be-evaluated model.

In some alternative embodiments, the calculating the performance evaluation metrics on the labelling information in the dataset and the inference result by means of a metrics evaluation component, to obtain the evaluation result corresponding to the to-be-evaluated model, includes: parsing the labelling information in the dataset and the inference result respectively, to obtain parsed labelling information and a parsed inference result; and performing performance evaluation calculation on the parsed labelling information and the parsed inference result based on a metrics evaluation algorithm, to obtain the evaluation result corresponding to the to-be-evaluated model.

In particular, for a runtime logic of the metrics evaluation component, the following process is included: parsing the labelling information in the dataset, and parsing the model inference result, performing performance evaluation calculation on the parsed labelling information and the parsed inference result by using the metrics evaluation algorithm, to obtain the evaluation result corresponding to the to-be-evaluated model.

In this way, by parsing the labelling information in the dataset and the inference result, and then performing performance evaluation calculation on the parsed labelling information and the parsed inference result based on the metrics evaluation algorithm, it is beneficial to obtain the evaluation result corresponding to the to-be-evaluated model.

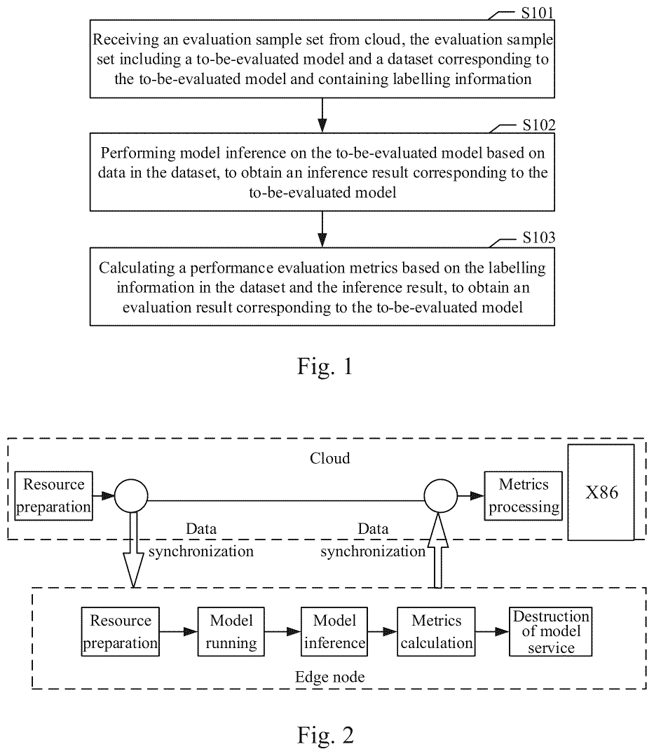

In order to facilitate understanding of the solution of embodiments of the present disclosure, referring to FIG. 2, FIG. 2 is a schematic flowchart corresponding to the method for evaluating a model service in an embodiment of the present disclosure. The method includes: preparing resources in the cloud, the resource preparation including: the to-be-evaluated model and the dataset corresponding to the to-be-evaluated model, then synchronizing the prepared resources to an edge node, running the to-be-evaluated model first at the edge node, then performing model inference using the to-be-evaluated model, and performing metrics calculation after the model inference. After performing the metrics calculation, the resources are released, that is, the model service is destroyed, and finally synchronizing a metrics calculation result to the cloud, where the metrics result is processed.

In some alternative embodiments, the method further includes: accessing, if the to-be-evaluated model is a deployed model service on the edge device, the deployed model service via a process interface accessible to an external network; and performing evaluation processing on the process interface, to obtain the evaluation result corresponding to the to-be-evaluated model.

In particular, for the existing model service on the edge device, that is, a running service already deployed on the edge device, the so-called service can expose the process interface that is accessible to the external network, and the model service may be accessed via the interface. This service is characterized by the fact that it can only be accessed via the network, and since it is not possible to acquire a source file of the model, it is not possible to upload the model file via a cluster server central end, in this regard, the evaluation of the model cannot be achieved in this scenario in the method described above. With regard to this unmanageable scenario, model evaluation may be performed by evaluating a third-party service interface, so as to acquire an evaluation metrics. In particular, by configuring a to-be-evaluated URL (Uniform Resource Locator) in the model center to replace the above processes such as model processing, this edge service URL is directly used as the URL of the model inference service for direct evaluation use, so that the evaluation result corresponding to the to-be-evaluated model may be obtained.

In this way, for the characteristic of evaluating for the existing model service on the edge, even if a model image cannot be exported, evaluation processing may be performed by performing on the process interface, thus achieving performance evaluation, improving security of the edge device.

In some alternative embodiments, the performing evaluation processing on the process interface, to obtain the evaluation result corresponding to the to-be-evaluated model, includes: acquiring the dataset from the cloud, the model inference component, and the metrics evaluation component; and performing evaluation processing on the process interface based on the model inference component and the metrics evaluation component, to obtain the evaluation result corresponding to the to-be-evaluated model.

In particular, when performing evaluation processing on the process interface based on the model inference component and the metrics evaluation component, as this evaluation method is similar to the solution of the above embodiment, detailed description thereof will be omitted.

In this way, for the existing model service on the edge, in the case that the model image cannot be exported, evaluation processing may be performed on the process interface, thus achieving the performance evaluation, improving the security of the edge device.

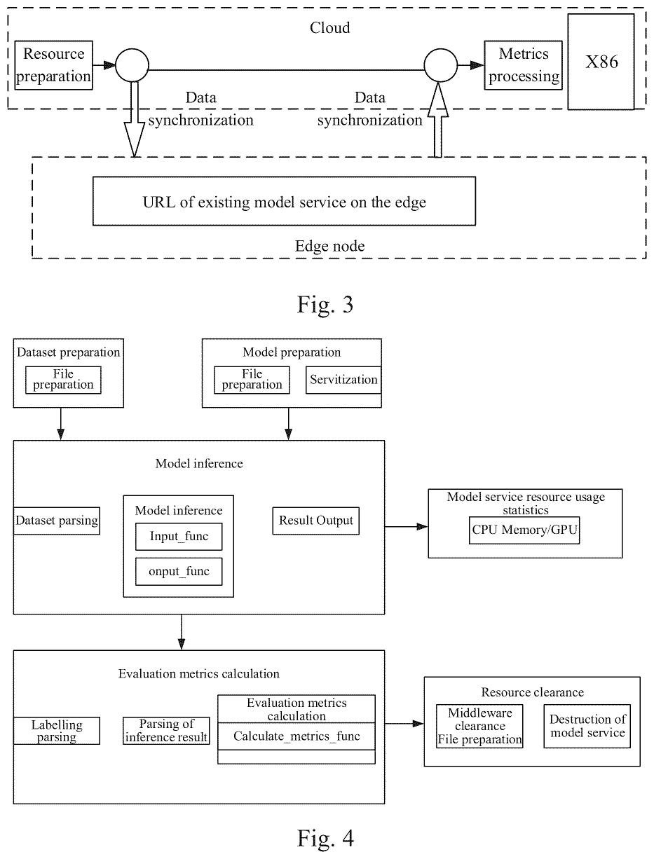

Referring to FIG. 3, FIG. 3 is a schematic flowchart corresponding to an existing method for evaluating a model service in an embodiment of the present disclosure. With regard to this unmanageable scenario, model evaluation may be performed by evaluating a third-party service interface, so as to obtain an evaluation metrics. By configuring a to-be-evaluated URL (Uniform Resource Locator) in the model center to replace the above processes such as model processing, this edge service URL is directly used as the URL of the model inference service for direct evaluation use.

In order to facilitate an overall understanding of the technical solution of the present disclosure, referring to FIG. 4, FIG. 4 is a schematic flowchart corresponding to the method for evaluating a model service in an embodiment of the present disclosure. The method includes: (1) preparation before evaluation: in particular, preparing a model service code source file and an evaluation sample set; (2) running the model service: sending the to-be-evaluated model and the evaluation sample set to the model inference component, based on a received performance evaluation request; (3) model inference: parsing the evaluation sample set first by means of the model inference component to obtain a parsed evaluation sample set, then, converting the parsed evaluation sample set into component input parameters (i.e., input_func, model inference input parameter script), and converting the format of the inference result into a component output format (i.e., output_func, model output conversion script) to obtain the inference result; and (4) performance evaluation: parsing the inference result and tags by means of the metrics evaluation component, and evaluating the inference result and the tags through metrics evaluation calculation (i.e., calculate_metrics_func, custom evaluation metrics calculation script), so as to obtain the performance evaluation metrics.

After obtaining the performance evaluation metrics, the method may further include: displaying the performance evaluation metrics by means of a display; after displaying the performance evaluation metrics, a middleware may also be cleared and the model service may be destroyed, so that the resources occupied by the to-be-evaluated model, i.e., CPU (Central Processing Unit/Processor)/memory/GPU (Graphics Processing Unit)) may be released.

The following describes an apparatus embodiment of the present disclosure that can be used to perform the method for evaluating a model service in the above embodiments of the present disclosure. For details not disclosed in the apparatus embodiment of the present disclosure, referring to the embodiments of the method for evaluating a model service in the present disclosure.

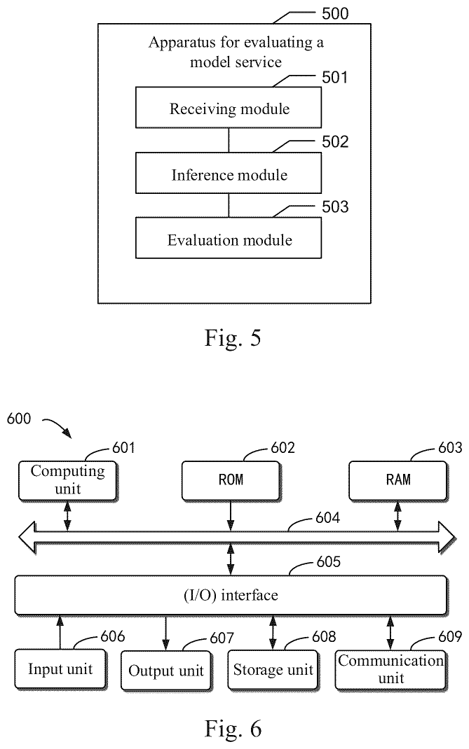

The present disclosure also provides an apparatus 500 for evaluating a model service, as shown in FIG. 5, including: a receiving module 501, configured to receive an evaluation sample set from cloud, the evaluation sample set including a to-be-evaluated model and a dataset corresponding to the to-be-evaluated model and containing labelling information; an inference module 502, configured to perform model inference on the to-be-evaluated model based on data in the dataset, to obtain an inference result corresponding to the to-be-evaluated model; and an evaluation module 503, configured to calculate a performance evaluation metrics based on the labelling information in the dataset and the inference result, to obtain an evaluation result corresponding to the to-be-evaluated model.

In some alternative embodiments, the inference module 502 is configured to perform model inference on the to-be-evaluated model based on data in the dataset, to obtain an inference result corresponding to the to-be-evaluated model, includes: perform model inference on the dataset corresponding to the to-be-evaluated model by means of a model inference component, to obtain the inference result corresponding to the to-be-evaluated model.

In some alternative embodiments, the inference module 502 is configured to perform model inference on the dataset corresponding to the to-be-evaluated model by means of a model inference component, to obtain the inference result corresponding to the to-be-evaluated model, includes: parse the data in the dataset corresponding to the to-be-evaluated model to obtain a parsed dataset; traverse the parsed dataset and convert the parsed dataset into input parameters of the model inference component; and perform inference based on the input parameters of the model inference component, to obtain the inference result corresponding to the to-be-evaluated model.

In some alternative embodiments, the evaluation module 503 is configured to calculate a performance evaluation metrics based on the labelling information in the dataset and the inference result, to obtain an evaluation result corresponding to the to-be-evaluated model, includes: calculate the performance evaluation metrics on the labelling information in the dataset and the inference result by means of a metrics evaluation component, to obtain the evaluation result corresponding to the to-be-evaluated model.

In some alternative embodiments, the evaluation module 503 is configured to calculate the performance evaluation metrics on the labelling information in the dataset and the inference result by means of a metrics evaluation component, to obtain the evaluation result corresponding to the to-be-evaluated model, includes: parse the labelling information in the dataset and the inference result respectively, to obtain parsed labelling information and a parsed inference result; and perform performance evaluation calculation on the parsed labelling information and the parsed inference result based on a metrics evaluation algorithm, to obtain the evaluation result corresponding to the to-be-evaluated model.

In some alternative embodiments, the evaluation module 503 is further configured to access, if the to-be-evaluated model is a deployed model service on the edge device, the deployed model service via a process interface accessible to an external network; and perform evaluation processing on the process interface, to obtain the evaluation result corresponding to the to-be-evaluated model.

In some alternative embodiments, the evaluation module 503 is configured to perform evaluation processing on the process interface, to obtain the evaluation result corresponding to the to-be-evaluated model, includes: acquire the dataset from the cloud, the model inference component, and the metrics evaluation component; and perform evaluation processing on the process interface based on the model inference component and the metrics evaluation component, to obtain the evaluation result corresponding to the to-be-evaluated model.

In the technical solution of the present disclosure, the acquisition, storage and application of personal information of a user involved are in conformity with relevant laws and regulations, and do not violate public order and good customs.

According to an embodiment of the present disclosure, the present disclosure further provides an electronic device, a readable storage medium, and a computer program product.

FIG. 6 shows a schematic block diagram of an electronic device 600 used to implement the embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processing, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, the electronic device 600 includes a computation unit 601, which may execute various appropriate actions and processes in accordance with a computer program stored in a read-only memory (ROM) 602 or a computer program loaded into a random access memory (RAM) 603 from a storage unit 608. The RAM 603 also stores various programs and data required by operations of the device 600. The computation unit 601, the ROM 602 and the RAM 603 are connected to each other through a bus 604. An input/output (I/O) interface 605 is also connected to the bus 604.

The following components in the device 600 are connected to the I/O interface 605: an input unit 606, for example, a keyboard and a mouse; an output unit 607, for example, various types of displays and a speaker; a storage device 608, for example, a magnetic disk and an optical disk; and a communication unit 609, for example, a network card, a modem, a wireless communication transceiver. The communication unit 609 allows the device 600 to exchange information/data with an other device through a computer network such as the Internet and/or various telecommunication networks.

The computation unit 601 may be various general-purpose and/or special-purpose processing assemblies having processing and computing capabilities. Some examples of the computation unit 601 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 601 performs the various methods and processes described above, for example, the method for evaluating a model service. For example, in some embodiments, the method for evaluating a model service may be implemented as a computer software program, which is tangibly included in a machine readable medium, for example, the storage device 608. In some embodiments, part or all of the computer program may be loaded into and/or installed on the device 600 via the ROM 602 and/or the communication unit 609. When the computer program is loaded into the RAM 603 and executed by the computation unit 601, one or more steps of the above method for evaluating a model service may be performed. Alternatively, in other embodiments, the computation unit 601 may be configured to perform the method for evaluating a model service through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for evaluating a model service, applied to an edge device, comprising:
receiving an evaluation sample set from cloud, the evaluation sample set comprising a to-be-evaluated model and a dataset corresponding to the to-be-evaluated model and containing labelling information;
performing model inference on the to-be-evaluated model based on data in the dataset, to obtain an inference result corresponding to the to-be-evaluated model; and
calculating a performance evaluation metrics based on the labelling information in the dataset and the inference result, to obtain an evaluation result corresponding to the to-be-evaluated model.

2. The method according to claim 1, wherein the performing model inference on the to-be-evaluated model based on data in the dataset, to obtain an inference result corresponding to the to-be-evaluated model, comprises:
performing model inference on the dataset corresponding to the to-be-evaluated model by means of a model inference component, to obtain the inference result corresponding to the to-be-evaluated model.

3. The method according to claim 2, wherein the performing model inference on the dataset corresponding to the to-be-evaluated model by means of a model inference component, to obtain the inference result corresponding to the to-be-evaluated model, comprises:
parsing the data in the dataset corresponding to the to-be-evaluated model to obtain a parsed dataset;
traversing the parsed dataset and converting the parsed dataset into input parameters of the model inference component; and
performing inference based on the input parameters of the model inference component, to obtain the inference result corresponding to the to-be-evaluated model.

4. The method according to claim 1, wherein the calculating a performance evaluation metrics based on the labelling information in the dataset and the inference result, to obtain an evaluation result corresponding to the to-be-evaluated model, comprises:
calculating the performance evaluation metrics on the labelling information in the dataset and the inference result by means of a metrics evaluation component, to obtain the evaluation result corresponding to the to-be-evaluated model.

5. The method according to claim 4, wherein the calculating the performance evaluation metrics on the labelling information in the dataset and the inference result by means of a metrics evaluation component, to obtain the evaluation result corresponding to the to-be-evaluated model, comprises:
parsing the labelling information in the dataset and the inference result respectively, to obtain parsed labelling information and a parsed inference result; and
performing performance evaluation calculation on the parsed labelling information and the parsed inference result based on a metrics evaluation algorithm, to obtain the evaluation result corresponding to the to-be-evaluated model.

6. The method according to claim 1, wherein the method further comprises:
accessing, if the to-be-evaluated model is a deployed model service on the edge device, the deployed model service via a process interface accessible to an external network; and
performing evaluation processing on the process interface, to obtain the evaluation result corresponding to the to-be-evaluated model.

7. The method according to claim 6, wherein the performing evaluation processing on the process interface, to obtain the evaluation result corresponding to the to-be-evaluated model, comprises:
acquiring the dataset from the cloud, model inference component, and metrics evaluation component; and
performing evaluation processing on the process interface based on the model inference component and the metrics evaluation component, to obtain the evaluation result corresponding to the to-be-evaluated model.

8. An electronic device, comprising:
at least one processor; and
a memory communicatively connected to the at least one processor; wherein,
the memory stores instructions executable by the at least one processor, and the instructions, when executed by the at least one processor, cause the at least one processor to perform operations for evaluating a model service, the operations comprising:
receiving an evaluation sample set from cloud, the evaluation sample set comprising a to-be-evaluated model and a dataset corresponding to the to-be-evaluated model and containing labelling information;
performing model inference on the to-be-evaluated model based on data in the dataset, to obtain an inference result corresponding to the to-be-evaluated model; and
calculating a performance evaluation metrics based on the labelling information in the dataset and the inference result, to obtain an evaluation result corresponding to the to-be-evaluated model.

9. The electronic device according to claim 8, wherein the performing model inference on the to-be-evaluated model based on data in the dataset, to obtain an inference result corresponding to the to-be-evaluated model, comprises:
performing model inference on the dataset corresponding to the to-be-evaluated model by means of a model inference component, to obtain the inference result corresponding to the to-be-evaluated model.

10. The electronic device according to claim 9, wherein the performing model inference on the dataset corresponding to the to-be-evaluated model by means of a model inference component, to obtain the inference result corresponding to the to-be-evaluated model, comprises:
parsing the data in the dataset corresponding to the to-be-evaluated model to obtain a parsed dataset;
traversing the parsed dataset and converting the parsed dataset into input parameters of the model inference component; and
performing inference based on the input parameters of the model inference component, to obtain the inference result corresponding to the to-be-evaluated model.

11. The electronic device according to claim 8, wherein the calculating a performance evaluation metrics based on the labelling information in the dataset and the inference result, to obtain an evaluation result corresponding to the to-be-evaluated model, comprises:
calculating the performance evaluation metrics on the labelling information in the dataset and the inference result by means of a metrics evaluation component, to obtain the evaluation result corresponding to the to-be-evaluated model.

12. The electronic device according to claim 11, wherein the calculating the performance evaluation metrics on the labelling information in the dataset and the inference result by means of a metrics evaluation component, to obtain the evaluation result corresponding to the to-be-evaluated model, comprises:
parsing the labelling information in the dataset and the inference result respectively, to obtain parsed labelling information and a parsed inference result; and
performing performance evaluation calculation on the parsed labelling information and the parsed inference result based on a metrics evaluation algorithm, to obtain the evaluation result corresponding to the to-be-evaluated model.

13. The electronic device according to claim 8, wherein the operations further comprises:
accessing, if the to-be-evaluated model is a deployed model service on the edge device, the deployed model service via a process interface accessible to an external network; and
performing evaluation processing on the process interface, to obtain the evaluation result corresponding to the to-be-evaluated model.

14. The electronic device according to claim 13, wherein the performing evaluation processing on the process interface, to obtain the evaluation result corresponding to the to-be-evaluated model, comprises:
acquiring the dataset from the cloud, model inference component, and metrics evaluation component; and
performing evaluation processing on the process interface based on the model inference component and the metrics evaluation component, to obtain the evaluation result corresponding to the to-be-evaluated model.

15. A non-transitory computer readable storage medium storing computer instructions, wherein the computer instructions are used to cause a computer to perform operations for evaluating a model service, the operations comprising:
receiving an evaluation sample set from cloud, the evaluation sample set comprising a to-be-evaluated model and a dataset corresponding to the to-be-evaluated model and containing labelling information;
performing model inference on the to-be-evaluated model based on data in the dataset, to obtain an inference result corresponding to the to-be-evaluated model; and
calculating a performance evaluation metrics based on the labelling information in the dataset and the inference result, to obtain an evaluation result corresponding to the to-be-evaluated model.

16. The storage medium according to claim 15, wherein the performing model inference on the to-be-evaluated model based on data in the dataset, to obtain an inference result corresponding to the to-be-evaluated model, comprises:
performing model inference on the dataset corresponding to the to-be-evaluated model by means of a model inference component, to obtain the inference result corresponding to the to-be-evaluated model.

17. The storage medium according to claim 16, wherein the performing model inference on the dataset corresponding to the to-be-evaluated model by means of a model inference component, to obtain the inference result corresponding to the to-be-evaluated model, comprises:
parsing the data in the dataset corresponding to the to-be-evaluated model to obtain a parsed dataset;
traversing the parsed dataset and converting the parsed dataset into input parameters of the model inference component; and
performing inference based on the input parameters of the model inference component, to obtain the inference result corresponding to the to-be-evaluated model.

18. The storage medium according to claim 15, wherein the calculating a performance evaluation metrics based on the labelling information in the dataset and the inference result, to obtain an evaluation result corresponding to the to-be-evaluated model, comprises:
calculating the performance evaluation metrics on the labelling information in the dataset and the inference result by means of a metrics evaluation component, to obtain the evaluation result corresponding to the to-be-evaluated model.

19. The storage medium according to claim 18, wherein the calculating the performance evaluation metrics on the labelling information in the dataset and the inference result by means of a metrics evaluation component, to obtain the evaluation result corresponding to the to-be-evaluated model, comprises:
parsing the labelling information in the dataset and the inference result respectively, to obtain parsed labelling information and a parsed inference result; and
performing performance evaluation calculation on the parsed labelling information and the parsed inference result based on a metrics evaluation algorithm, to obtain the evaluation result corresponding to the to-be-evaluated model.

20. The storage medium according to claim 18, wherein the operations further comprises:
accessing, if the to-be-evaluated model is a deployed model service on the edge device, the deployed model service via a process interface accessible to an external network; and
performing evaluation processing on the process interface, to obtain the evaluation result corresponding to the to-be-evaluated model.
